(19) United States
(12) Patent Application Publication
(10) Pub. No.: US 2008/0286556 A1
(43) Pub. Date: Nov. 20, 2008

(54) SUPER-HYDROPHOBIC WATER REPELLANT POWDER

(76) Inventors: Brian R. D'urso, Clinton, TN (US); John T. Simpson, Clinton, TN (US)

Correspondence Address: AKERMAN SENTERFITT, 222 LAKEVIEW AVENUE, 4TH FLOOR, WEST PALM BEACH, FL, 33401, US

(21) Appl. No.: 11/749,852

(22) Filed: May 17, 2007

(51) Int. Cl. B31D 3/00; C08J 9/00

(52) U.S. Cl. 428/315.5; 216/56

(57) ABSTRACT

A composition of matter is a plurality of solid particles of at least 100 nm to about 10 μm in size having a plurality of nanopores where at least some of the nanopores provide flow through porosity, and the surface of the particles displays a plurality of spaced apart nanostructured features with a contiguous material protruding at the surface and optionally at least one interpenetrating recessing contiguous material. The particles are superhydrophobic when the protruding material is hydrophobic or a hydrophobic coating conforms to the surface of the particle. Articles with superhydrophobic surfaces can be formed by the coating of the particles on a solid substrate.

### STATEMENT REGARDING FEDERALLY SPONSORED RESEARCH OR DEVELOPMENT

The United States Government has rights in this invention pursuant to Contract No. DE-AC05-00OR22725 between the United States Department of Energy and UT-Battelle, LLC.

### CROSS-REFERENCE TO RELATED APPLICATIONS

Not applicable.

### FIELD OF THE INVENTION

The present invention relates to powder having nanostructured hydrophobic or super-hydrophobic surfaces.

### BACKGROUND OF THE INVENTION

When a material is of a porous nature, liquids such as water can generally migrate through the material particularly where the pores are interconnected and of dissimilar size. However, the ability for water to diffuse through a porous structure depends on the hydrophilicity of the structure and the size of the pores and the tortuous nature of the path through the structure. A hydrophobic surface is generally defined and defined herein as that which has a contact angle greater than 90 degrees with a drop of water. Hydrophobic materials include many well-known, commercially available polymers and the largest contact angles are for those of perfluorinated hydrocarbons, which display contact angles to about 120 degrees on a smooth surface. A super-hydrophobic surface is generally defined and defined herein as that which has a contact angle greater than 150 degrees with a drop of water and can be up to nearly the limit of 180 degrees. To achieve these higher contact angles the geometry of the surface can not be smooth. For example, the lotus leaf surface is known to be naturally super-hydrophobic due to the texture of its waxy surface. When the contact angle is greater than 150 degrees the affinity of the surface for the gas is dramatically greater than that of the water. Hence, a super-hydrophobic powder could be useful for the formation of coatings and membranes with unique properties.

Coatings are required on substrates for a host of applications. The inclusion of a super-hydrophobic particle as the base of the coating permits many features presently difficult to produce. One such use is for coatings which due to their superhydrophobicity resist moisture to the extent that soiling of the surface is difficult. This occurs as water is efficiently shed from the surface, carrying with it readily dissolved and wetted particulates. Another application for such a surface is for dramatically lowering the resistance to fluid flow at that surface. As the affinity for the gas is much higher than the water, the resistance can be primarily defined by the viscosity of the water with air or other gas rather than the solid surface. The combining of the particles at a surface permits the formation of a porous membrane, which has the potential for gas-liquid separation.

For example, membranes are expected to play a greater role in gas-liquid separation as it inherently can reduce the environmental impact and costs of industrial processes. Gas separation membranes offer a number of benefits over other gas separation technologies, such as the cryogenic distillation of air, condensation to remove condensable vapors from gas mixtures, and reactive absorption to remove water soluble liquids from gases. These methods require a gas-to-liquid phase change in the gas mixture that is to be separated with a phase change that can add a significant energy cost to the separation cost. The lack of mechanical complexity in membrane systems is an advantage over other technologies for gas-liquid separation. Membrane gas separation has the potential to avoid the costs and equipment required to evoke a phase change.

The key properties for liquid gas separation membranes are high flux (permeability), selectivity, processability, stability, and cost. Presently most membranes are based on polymeric films where a thin polymer has a selective solubility for a gas in the polymer or is of a PIM (polymer of intrinsic microporosity) nature where the structure of the polymer leads to pores of inherently less than about 2 nm. Polymeric films for gas-liquid separation have also been formed with gas-permeable pores where the pores are independent channels with equal small pore size and with a uniform distribution by forming channels by laser drilling. Hence, either molecular interactions (solubility) alone or size excluding pores have been used.

Super-hydrophobic powders have the potential to improve a variety of existing technologies profoundly and allow the development of novel technologies. New powders which have the appropriate surface structure are therefore needed to render them super-hydrophobic and to allow their use in a wide variety of structures and applications.

### SUMMARY OF THE INVENTION

A composition of matter is a plurality of solid particles of at least 100 nm to about 10 μm in size, where the particles have a plurality of nanopores that permits flow through porosity, and a plurality of spaced apart nanostructured features of a contiguous material protruding at the surface. The composition can also contain one or more recessing contiguous material interpenetrating with the protruding material. The protruding material can be hydrophobic or a hydrophobic coating layer conforming to the features can be included. The coating layer can be a perfluorinated organic material. One or more of the materials of the composition can be a glass.

An article can be formed that has a solid substrate with a coating disposed on the substrate, where the coating has a plurality of solid particles at least 100 nm to about 10 μm in size. The particles have a plurality of nanopores, with at least some of the nanopores provide flow through porosity, and a plurality of spaced apart nanostructured surface features from a contiguous material with surface features protruding at the surface and optionally at least one interpenetrating recessing contiguous material, where the protruding material is hydrophobic or where the features are coated with a hydrophobic coating layer such as a perfluorinated organic material. A binder can be present to promote adherence of the coating to the substrate. The substrate can be a porous structure such as a woven cloth. The nanoporous particles can include a glass.

Porous particles can be prepared by a method where a composition of two or more interpenetrating contiguous materials that are phase separated is converted into particles at least 100 nm to about 10 μm in size and etched such that one of the materials in the composition etches to a lesser extent than other materials to form a plurality of spaced apart nanostructured surface features of the less etched material protruding at the surface where the more extensively etched material or materials form at least some pores and when not entirely removed by etching are present as recessing contiguous materials. One or more of the contiguous interpenetrating materials can be glasses. The interpenetrating phase separated structure can be formed where two materials are homogeneous at a given temperature and undergo spinodal decomposition by a change in temperature. The formation of particles from the interpenetrating contiguous materials can involve pulverizing, chopping, or grinding and the etching step can involve wet etching.

### BRIEF DESCRIPTION OF THE DRAWINGS

FIG. 1 is a scanned scanning electron microscopy image (SEM) showing particles of an embodiment of the invention comprising irregularly shapes particles greater than about 0.2 μm to about 7 μm having protruding features are about 200 nm in width and smaller.

For a better understanding of the present invention, together with other and further objects, advantages and capabilities thereof, reference is made to the following disclosure and appended claims in connection with the above-described drawing.

### DETAILED DESCRIPTION OF THE INVENTION

The present invention provides super-hydrophobic particles where the particles are formed from an interpenetrating blend or composite of a plurality of materials where at least one material protrudes from the other materials at the surface of the particle after the removal of at least some of one or more materials. The particles have a plurality of pores that permit flow of a gas or a liquid through the particles. Each material is contiguous and the different materials form an interpenetrating structure. The particles are greater than 100 nm to about 10 μm in size and have protrusions that are small relative to the size of the particles such that a plurality of protrusions is present on a given particle. The particles have at least one hydrophobic material included in the plurality of materials, including the protruding material, or the particle is coated with a hydrophobic material such that the surface retains the general topography of protrusions from the surface of the particles and the surface is hydrophobic. The particles have pores, and a portion of these pores have connectivity through the particle by the removal of some or all of at least one of the non-protruding (recessing) materials. The combination of a hydrophobic protruding material or hydrophobic coated surface with the topography of the particle results in super-hydrophobicity of the particles.

The hydrophobic material included in the particle or a coating on the particle can be any hydrophobic material. Preferably it is a perfluorinated or fluorinated organic material. The coating can be a fluorinated self-assembly monolayer.

There are no limits to the variations of sizes and shapes of the nanostructured surface. The blend or composite used to form the particles may be made from any materials differentially etchable by any known etching method or combination of methods. The materials comprising the particles can be any combination of glasses, metals, ceramics, and polymers.

The respective interpenetrating contiguous materials used to form the particles are differentially etchable (i.e. have different etch rates), when subjected to one or more etchants and have an interconnected structure with two or more phases, such as that resulting from spinodal decomposition. The phase separation permits the generation of a protruding phase and a recessive phase by differentially etching the particles where one material phase is removed to a much greater degree than the other phase or phases. In the limit the entire more readily etched recessive phase may be removed entirely. Porosity results from the etching of the recessive phase to the extent that channels are formed within the particle, some of which may interconnect to form a continuous void generally, but not necessarily, with a tortuous path that extends from one side of the particle to another.

The protrusive material can have edges that are sharp or rounded depending upon the etching rate of the second (protrusive) material. For example, when the protrusive material can be etched at a significant rate and the recessive material can be etched at yet a higher rate, surface features result with sharp or tapered protrusive features as the proportion of the initial surface removed decreases with the depth of the etch leaving a peak or a ridge depending upon the shape of the protrusive material before etching. When the protrusive material undergoes very little or no etching the features can be blunter, more rounded rather than sharp.

The surface feature dimensions comprise width and length in the case of rectangular features, or diameter in the case of cylindrically shaped features that can be of any size smaller than the size of the entire particle. These features will generally have dimensions that are less than 1 μm and are preferably have dimensions that are less than 400 nm. Generally, but not necessarily, the feature dimensions are of a relatively uniform distribution displaying a random pattern of shapes.

One method for producing the pre-etched composition starts with a plurality of materials that are more miscible at a first temperature but less immiscible at a second temperature. For example, the mixture of materials can be miscible at a particular temperature and then separated into two or more phases when cooled or heat to a temperature where the materials are immiscible. Phase separation via spinodal decomposition, which results in two contiguous phases, is one available mechanism for formation of the contiguous interpenetrating materials. Nucleated decomposition is another mechanism for achieving such phase separated materials.

The particles can be prepared in any manner that results in a contiguous protruding phase with an optional interpenetrating contiguous recessive phase and the formation of the particles can occur prior to, subsequent to, or simultaneous with the surface features and pores. In one preferred embodiment, the composition of interpenetrating contiguous materials is formed and then partitioned into particles followed by differential etching of the materials to form the surface features and the pores. The partitioning of the composition of interpenetrating contiguous materials can be carried out by any means including pulverizing, chopping, or grinding the material. Other means can be used to form the particles and the particles can vary from uniform regular shapes to mixed irregular shapes. The particles can range from opaque to transparent. The particles can be separated using sieves or other methods as desired to achieve a desired particle size distribution.

The etching of at least one of the materials in the particles can be carried out before or after the formation of the particles. A preferred embodiment involves etching after the formation of the particle. In this manner the total surface area is increased permitting more rapid etching than from some other possible form before partitioning the interpenetrating contiguous materials into particles, such as a block or a sheet. Etching after partitioning into particles also permits for the formation of particles where all facets of the particle have essentially the same kind of surface features. Where partitioning occurs after the etching, the relative depth between the protruding material and the recessing material can vary from one facet to another. The uniformity of the facet surfaces can be preferred for some applications that use the particles of the invention and non-uniform facets can be preferred for other applications. Furthermore, the particles can be processed into a particular form such as an aggregate structure with particles optionally fixed with a binder prior to etching in the formation of a final article for use of the superhydrophobic particles.

The etching process can be of any known technique, such as contacting a fluid to remove selectively one material over other materials. The fluid can be a liquid or a gas and can be diluted with a non-etchant. Plasma etching or other isotropic etch techniques can be employed. Mixtures of etchants can be used where all etchants are appropriate for the etching of a single material, some materials, or all materials in the composition, or where different etchants target specific materials within the composition. The product of the etchant with the materials of the composition of interpenetrating contiguous materials can be a gas, liquid or solid and various means can be used to promote the separation of the product from the freshly exposed portion of the interpenetrating contiguous materials. Etchants are those known to etch any specific material used to form the composition of interpenetrating contiguous materials. For example, aqueous hydrofluoric acid is an appropriate etchant for silica and many glasses and ceramics. Other acids and bases can be used as etchants for appropriate materials and even solvents can be used as etchants with appropriate materials. The only requirement of the etchant or etchant mixture is that it can etch one of a mixture of interpenetrating contiguous materials at a greater rate than other materials in the mixture such that the desired surface texture can be generated.

Once the desired particles with a desired particle size, particle shape, surface texture and pore content are generated, the particles can be rendered superhydrophobic. Superhydrophobic particles can result by coating the entire particle or the protruding material of the particle with a hydrophobic coating material. The coating is preferably a fluorinated material such as one that contains a perfuorinated alkyl or other organic moiety or any other highly hydrophobic materials. The coating material can be a self-assembly monolayer, a coupling agent, a sputtered material, or any other material that readily conforms to the surface and can be controlled such that the surface features formed upon etching are not filled or otherwise planerized during the coating process to an extent where superhydrophoicity is lost. The treatment of the particles with a coating material can be carried out after further processing the particles into a desired article. For example an aggregate of the particles can be formed with or without the aid of a binder prior to coating the particles to yield a stable superhydrophobic particulate surface.

Once the superhydrophobic particles are formed they can be used to generate a variety of articles, such as where they are used as discrete particles in a powder as agglomerates or bound to each other or to an additional substrate. The particles can be dispersed onto a surface to render that surface superhydrophobic. The superhydrophobic powder can be directly applied to many surfaces including wood products, textiles, bricks, cinder blocks, paper products, or any porous material. As indicated above, the steps of generating the superhydrophobic properties can be carried out after the elaboration of the particles into an article. These steps of rendering the particles superhydrophobic, including etching and coating, are optionally performed prior to or after combining the particles in some sort of array or aggregate but before combining with a substrate to form a desired article. The elaboration of the particles into a useful form can include the addition of a binder to the particles. Furthermore, the binder can be any that chemically or physically locks the particles to each other or a substrate as long as the binder permits the maintenance or generation of the superhydrophobic surface. The use of a binder allows the application of the particles to nearly any surface including glasses, plastics, metals, and ceramics. Solvents and other processing aids can be included to the binder to facilitate binding and/or direct the binder to a desired portion of the particles and/or substrates. The use of such binders permits the formation of membranes, often with a porous substrate such as a woven fabric.

The present invention can be used to make a variety of articles. For example, articles can include superhydrophobic coatings for a variety of surfaces including watercraft hulls, construction, and liners for pipes and conduits and for the fabrication of membranes for gas separation. When the particle size and the surface features are sufficiently small, superhydrophobic transparent coatings for optical surfaces can be formed.

### EXAMPLE

The present invention is further illustrated by the following specific Example, which should not be construed as limiting the scope or content of the invention in any way.

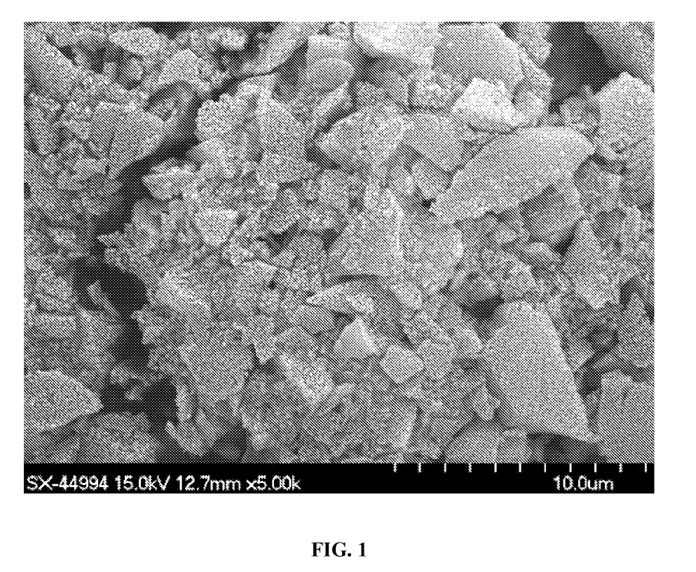

A sample of EX24 glass (having a composition, in wt %, 65.9 SiO₂, 26.3 B₂O₃, and 7.8 Na₂O) having a thickness of 1 mm was heat treated for 20 min at 720° C. to induce phase separation. The glass was then ground to a powder. The powder was subsequently etched with 5% HF to produce a porous structure where essentially only a portion of the silica glass remained. The resulting glass powder is extremely hydrophilic (sponge like). The powder was then converted from being hydrophilic to hydrophobic after drying by applying a hydrophobic self-assembled monolayer by immersing the powder in a solution of (tridecafluoro-1,1,2,2-tetrahydrooctyl)-trichlorosilane in hexanes and ultimately curing the monolayer by heating the powder at 110° C. for 15 minutes. A scanning electron microscope image of these particles is shown in FIG. 1 where all particles have a cross-section of more than about 0.5 μm to about 7 μm and protruding features of about 100 to 200 nm in width.

A hydrophilic powder, as prepared at the intermediate stage in the Example, can be suspended in water containing a bonding agent and applied to a substrate. The bound powder can then be converted to a superhydrophobic state by applying a hydrophobic self-assembled monolayer by contacting the powder coated substrate with (tridecafluoro-1,1,2,2-tetrahydrooctyl)-trichlorosilane, for example as a hexane solution, or other fluorinated bonding agent and ultimately curing the monolayer by heating the powder

A hydrophobic powder, as prepared in the Example, can be suspended in acetone containing a small amount of a polystyrene or polyacrylate resin as a binder. The suspension can be painted or sprayed onto a substrate. Upon evaporation of the solvent, the superhydrophobic powder is adhered to the substrate surface by the binder imparting a superhydrophobic surface to the substrate.

A hydrophobic powder, as prepared in the Example, can be suspended in acetone containing a small amount of polystyrene as a binder and coated onto cloth to form a membrane. The super hydrophobic membrane is porous and permits the passage of gases through the membrane. As the membrane is superhydrophobic, water and aqueous solutions are restricted from the membrane allowing the separation of gas from water upon generation of an appropriate pressure differential across the membrane.

While there has been shown and described what are at present considered the preferred embodiments of the invention, it will be obvious to those skilled in the art that various changes and modifications can be prepared therein without departing from the scope of the inventions defined by the appended claims.

We claim:

1. A composition of matter, comprising a plurality of solid particles of at least 100 nm to about 10 μm in size, said particles having a plurality of nanopores, wherein at least some of said nanopores provide flow through porosity, and a plurality of spaced apart nanostructured features comprising a contiguous material protruding at the surface.

2. The composition of claim 1, further comprising at least one recessing contiguous material interpenetrating with said protruding material.

3. The composition of claim 1, wherein said protruding material is hydrophobic.

4. The composition of claim 1, further comprising a hydrophobic coating layer conforming to said features.

5. The composition of claim 4, wherein said coating layer comprises a perfluorinated organic material.

6. The composition of claim 1, wherein at least one of said materials comprises a glass.

7. An article, comprising:
a solid substrate;
a coating disposed on said substrate, said coating comprising a plurality of solid particles at least 100 nm to about 10 μm in size, said particles having a plurality of nanopores, wherein at least some of said nanopores provide flow through porosity, and a plurality of spaced apart nanostructured surface features comprising a contiguous material with surface features protruding at the surface wherein said protruding material is hydrophobic or wherein said features are coated with a hydrophobic coating layer.

8. The article of claim 7, wherein said coating further comprises at least one recessing contiguous material interpenetrating with said protruding material.

9. The article of claim 7, further comprising a binder to promote adherence of said coating to said substrate.

10. The article of claim 7, wherein said substrate is porous.

11. The article of claim 10, wherein said substrate is a woven cloth.

12. The article of claim 7, wherein said hydrophobic coating layer comprises a perfluorinated organic material.

13. The article of claim 7, wherein at least one of said materials comprises a glass.

14. A method of forming porous particles, comprising the steps of:
providing a composition comprising a first contiguous material and at least a second contiguous material different from said first material, wherein said first and second materials are phase separated and interpenetrating and wherein said first material has a higher susceptibility to a at least one preselected etchant than said second material;
generating particles from said composition; and
etching said particles in said etchant to form a plurality of solid particles at least 100 nm to about 10 μm in size, said particles having a plurality of nanopores, wherein at least some of said nanopores provide flow through porosity, and a plurality of spaced apart nanostructured surface features comprising a contiguous material with surface features protruding at the surface and optionally at least one interpenetrating recessing contiguous material.

15. The method of claim 14, further comprising the step of applying a hydrophobic coating layer on surfaces of said particles.

16. The method of claim 14, wherein said first material comprises a first glass and said second material comprises a second glass different from said first glass.

17. The method of claim 14, wherein said providing step comprises changing the temperature of a homogeneous mixture of said first and second materials to induce spinodal decomposition into said phase separated interpenetrating composition.

18. The method of claim 14, wherein said etching step comprises wet etching.

19. The method of claim 14, wherein said generating step comprises pulverizing, chopping, or grinding.
